(19) United States
(12) Patent Application Publication
(10) Pub. No.: US 2026/0118572 A1
(43) Pub. Date: Apr. 30, 2026

(54) DISPLAY DEVICE

(71) Applicant: NALUX CO., LTD., Osaka (JP)

(72) Inventor: Tatsuya TABEI, Osaka (JP)

(73) Assignee: NALUX CO., LTD., Osaka (JP)

(21) Appl. No.: 19/345,449

(22) Filed: Sep. 30, 2025

Related U.S. Application Data
(63) Continuation of application No. PCT/JP2024/037911, filed on Oct. 24, 2024.

(51) Int. Cl. F21V 8/00

(52) U.S. Cl. CPC G02B 6/0028

(57) ABSTRACT

A display device including plural light sources, plural sub light guides and a main light guide, wherein each sub light guide is of an elongated shape and one of the plural light sources is provided at an end of each sub light guide, the main light guide is provided with a display surface, a first reflecting surface and a second reflecting surface, the display surface and the first reflecting surface are adjacent to each other, the display surface and the second reflecting surface face each other, and each sub light guide is connected to the main light guide in an area between the first reflecting surface and the second reflecting surface.

### CROSS REFERENCE TO RELATED APPLICATION

This is a Continuation of International Patent Application No. PCT/JP2024/037911 filed Oct. 24, 2024, which designates the U.S. The content of this application is hereby incorporated by reference.

### TECHNICAL FIELD

The subject disclosure relates to a display device.

### BACKGROUND ART

Display devices provided with light sources such as LEDs and light guides have been developed (for example, patent documents 1 and 2). By changing an irradiation time and intensity of each of different types of plural light sources, such display devices can provide various display patterns. Such display devices can serve advantageously as interior illumination devices of cars, exterior signal lights of cars, illumination devices for amusement machines, display devices for display of operating states of electronic devices, backlighting devices for capacitive-type touch sensors, devices for man-machine interface and the like.

However, a display device provided with light sources and light guides, which can provide a uniform intensity of luminance on a display area, has not been developed. Accordingly, there is a need for a display device provided with light sources and light guides, which can provide a uniform intensity of luminance on a display area.

### PATENT DOCUMENT

Patent document 1: JP2013143252A
Patent document 2: JP2019129135A

### SUMMARY

A display device including plural light sources, plural sub light guides and a main light guide, wherein each sub light guide is of an elongated shape and one of the plural light sources is provided at an end of each sub light guide, the main light guide is provided with a display surface, a first reflecting surface and a second reflecting surface, the display surface and the first reflecting surface are adjacent to each other, the display surface and the second reflecting surface face each other, and each sub light guide is connected to the main light guide in an area between the first reflecting surface and the second reflecting surface and wherein each sub light guide is configured so as to transmit rays of light emitted by a light source at an end of each sub light guide through internal reflection and the main light guide is configured such that rays of light received from each sub light guide are reflected on the first reflecting surface then directly or after having been reflected on the second reflecting surface reach the display surface.

### BRIEF DESCRIPTION OF DRAWINGS

FIG. 1A shows a plan view of an example of a display device according to an embodiment;

FIG. 1B shows a front view of the example of a display device according to the embodiment:

FIG. 1C shows a side view of the example of a display device according to the embodiment;

FIG. 2 shows a path of a ray of light emitted by the light source 101;

FIG. 3 shows a xy cross section of the display device;

FIG. 4A illustrates how to connect a sub light guide to the main light guide;

FIG. 4B shows a cross section D-D, the line D-D being shown in FIG. 4A;

FIG. 5A shows a cross section A-A, the line A-A being shown in FIG. 4A;

FIG. 5B shows a cross section B-B, the line B-B being shown in FIG. 4A;

FIG. 5C shows a cross section C-C, the line C-C being shown in FIG. 4A;

FIG. 5D shows a cross section C′-C′, the line C′-C′ being shown in FIG. 4A;

FIG. 6A shows a cross section A-A, the line A-A being shown in FIG. 4A;

FIG. 6B shows a cross section B-B, the line B-B being shown in FIG. 4A;

FIG. 6C shows a cross section C-C, the line C-C being shown in FIG. 4A;

FIG. 6D shows a cross section, C′-C′ the line C′-C′ being shown in FIG. 4A;

FIG. 7 is a perspective view of the sub light guides and the first reflecting surface R1 of the main light guide 300;

FIG. 8 shows the first reflecting surface R1;

FIG. 9A shows a cross section that is perpendicular to the direction of the plural linear grooves on the first reflecting surface R1;

FIG. 9B illustrates the cross section PL shown in FIG. 9A;

FIG. 10 shows an xy cross section of the first reflecting surface R1 and the surrounding portions of the main light guide 300;

FIG. 11 shows a view from diagonally above of the sub light guides and the main light guide;

FIG. 12 shows an area on the display surface E, from the area ray of light via the sub light guide 401 being delivered;

FIG. 13A shows a plan view of the sub light guide 403, which is connected to the main light guide 300 in a z-coordinate range, z coordinates in the z-coordinate range being greater than corresponding z coordinates of a z-coordinate range in which any other sub light guide is connected to the main light guide 300;

FIG. 13B shows a cross section F-F, the line F-F being shown in FIG. 13A;

FIG. 14A shows a plan view of the display device like FIG. 1A;

FIG. 14B shows a diagram showing distributions of intensity of luminance I1, I2 and I3 in the z-axis direction on the display surface E generated by rays of light that have passed respectively through each of the sub light guides 401, 402 and 403;

FIG. 15 is a perspective view of a display device including a light source provided with a device for adjusting an angle of divergence;

FIG. 16 shows a cross section of the display device including the light source provided with the device for adjusting an angle of divergence;

FIG. 17 shows a plan view of sub light guides each of which is provided with a light source with a device for adjusting an angle of divergence;

FIG. 18 is a perspective view of a display device in which plural light sources are arranged at relatively great intervals in the z-axis direction; and

FIG. 19 is a perspective view of a display device in which two sets of three light sources (401, 402, 403) and (404,405,406) are placed in the vicinity of the both ends of a side in the z-axis direction of the display surface.

### DESCRIPTION OF EMBODIMENTS

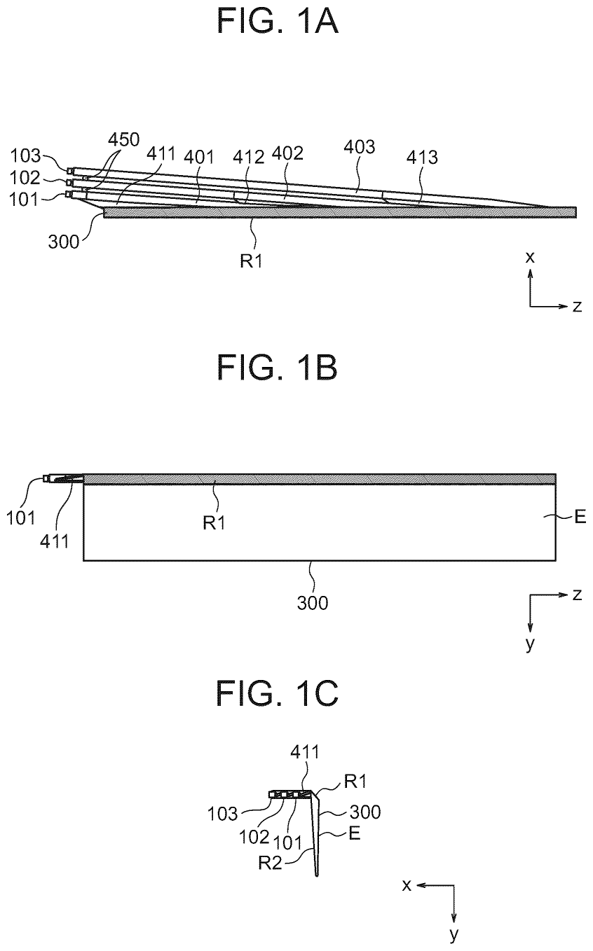

FIG. 1A shows a plan view of an example of a display device according to an embodiment.

FIG. 1B shows a front view of the example of a display device according to the embodiment.

FIG. 1C shows a side view of the example of a display device according to the embodiment.

An xyz coordinate system is defined as below. Directions of an x-axis, a y-axis and a z-axis are determined such that the direction of the y-axis is perpendicular to the plane of FIG. 1A, the direction of the x-axis is perpendicular to the plane of FIG. 1B and the direction of the z-axis is perpendicular to the plane of FIG. 1C. The origin of the xyz coordinate system will be described later.

A display device according to the embodiment includes plural light sources, plural sub light guides and a main light guide 300. Each of the plural light sources is provided at an end of one of the plural sub light guides. In the example shown in the drawings, each of the plural sub light guides is represented by 401, 402 and 403 and each light source provided at an end of each sub light guide is represented by 101, 102 and 103. As shown in FIG. 1C, the main light guide 300 is provide with a first reflecting surface R1, a second reflecting surface R2 and a display surface E, the display surface E being perpendicular to the X-axis direction.

The display surface E is parallel to the y-axis and the z-axis. In the present example, the display surface is a rectangular flat surface that has sides in the y axis direction and in the z axis direction. A length of the sides in the y-axis direction is 50 millimeters and a length of the sides in the z-axis direction is 300 millimeters. In general, the shape of a display surface is not restricted to rectangles. Further, the display surface can be a curved one as described later. At one of the vertexes of the rectangle formed by sides in the y-axis direction and in the z-axis direction, the origin of the xyz coordinate system is located. Coordinates along the y-axis and along the z-axis are determined such that coordinates of a point on the sides in the y-axis direction and in the z-axis direction of the rectangle are positive. Coordinates along the x-axis are determined such that coordinates of the plural light sources are positive. In the present example, at the vertex at the upper left corner of the rectangle shown in FIG. 1B, the origin is located.

The light sources 101, 102 and 103 can be light emitting diodes (LEDs). As material of the main light guide 300 and the plural sub light guides 401, 402 and 403, a highly transparent thermoplastic resin such as polymethylmethacrylate, polycarbonate and polyolefin resin is preferable. The main light guide 300 and the plural sub light guides 401, 402 and 403 can be easily produced through injection molding.

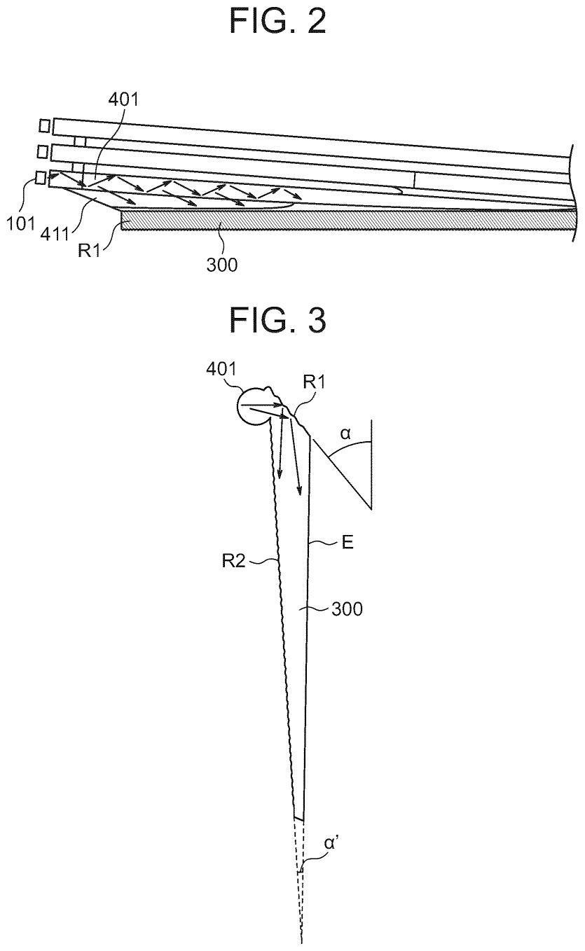

FIG. 2 shows paths of rays of light emitted by the light source 101. FIG. 2 is a plan view of the display device like FIG. 1A. Each sub light guide is of an elongated shape like a rod. Rays of light emitted by the light source 101 travel inside the sub light guide 401 through internal reflection that repeats itself. Some of rays of light travelling inside the sub light guide 401 reach the main light guide 300 through a connecting member 411.

FIG. 3 shows a xy cross section of the display device. FIG. 3 shows the sub light guide 401 alone among the plural sub light guides. The main light guide 300 is provide with the first reflecting surface R1, the second reflecting surface R2 and the display surface E. The display surface E is adjacent to the first reflecting surface R1 and faces the second reflecting surface R2. The sub light guide 401 or the connecting member 411 thereof is connected to the main light guide 300 at an area between the first reflecting surface R1 and the second reflecting surface R2. A supplementary angle α of an angle between the first reflecting surface R1 and the display surface E is in a range from 30 degrees to 50 degrees. Rays of light that have reached the main light guide 300 via the sub light guide 401 are reflected by the first reflecting surface R1 and then delivered by the display surface E directly or after having been reflected by the second reflecting surface R2. The second reflecting surface R2 and the display surface E is parallel to each other or an acute angle α′ formed by both surfaces is 20 degrees or smaller. In some cases, a reflecting surface is provided with plural grooves or textured as described below. In these cases, the angle formed by the two surfaces is determined using an imaginary plane that is obtained by an averaged value of depth of the grooves or the texture.

More detailed description on the main light guide and the sub light guides will be given below.

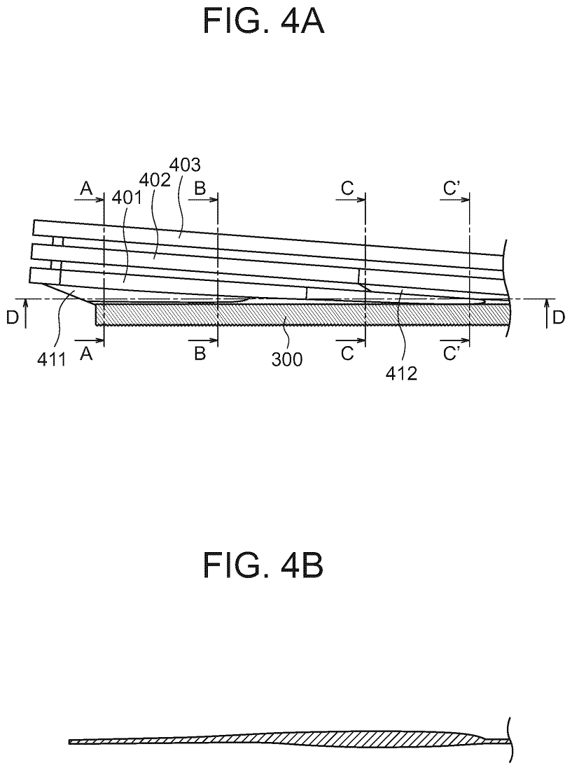

FIG. 4A illustrates how to connect a sub light guide to the main light guide. FIG. 4A is a plan view of the display device like FIG. 1A.

FIG. 4B shows a cross section D-D, the line D-D being shown in FIG. 4A. The cross section D-D is a cross section that is perpendicular to the x-axis.

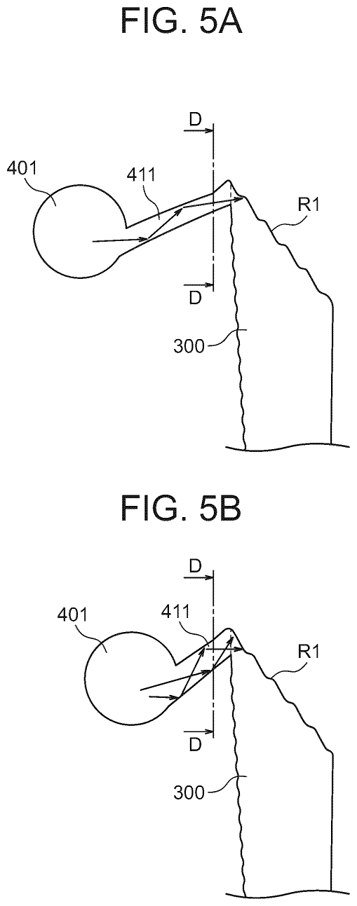

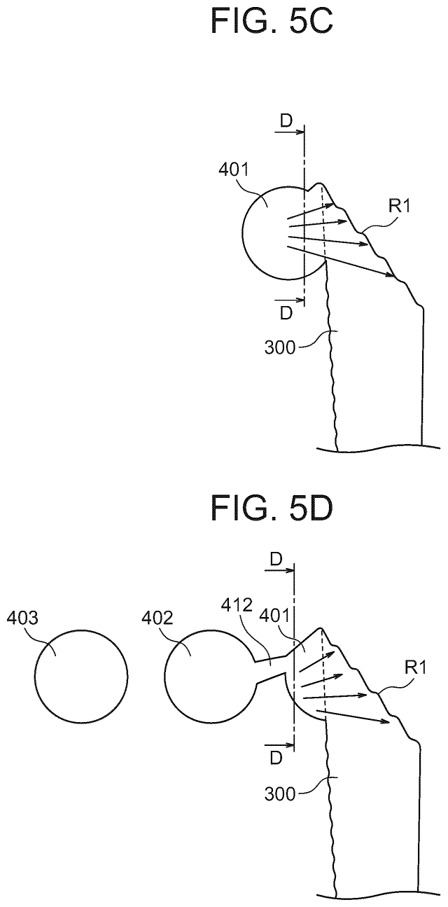

FIG. 5A shows a cross section A-A, the line A-A being shown in FIG. 4A. The cross section A-A is a cross section that is perpendicular to the z-axis.

FIG. 5B shows a cross section B-B, the line B-B being shown in FIG. 4A. The cross section B-B is a cross section that is perpendicular to the z-axis.

FIG. 5C shows a cross section C-C, the line C-C being shown in FIG. 4A. The cross section C-C is a cross section that is perpendicular to the z-axis.

FIG. 5D shows a cross section C′-C′, the line C′-C′ being shown in FIG. 4A. The cross section C′-C is a cross section that is perpendicular to the z-axis.

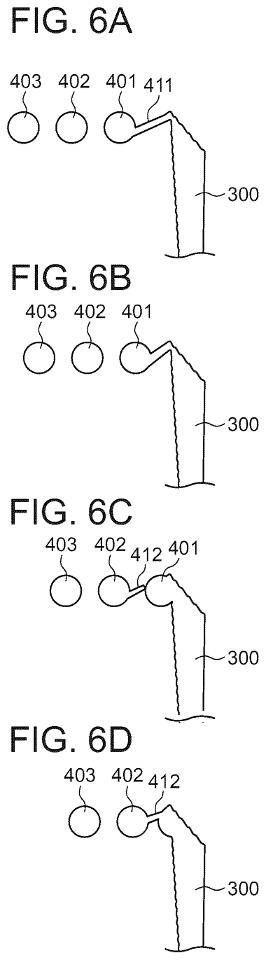

FIG. 6A shows a cross section A-A, the line A-A being shown in FIG. 4A.

FIG. 6B shows a cross section B-B, the line B-B being shown in FIG. 4A.

FIG. 6C shows a cross section C-C, the line C-C being shown in FIG. 4A.

FIG. 6D shows a cross section, C′-C′ the line C′-C′ being shown in FIG. 4A.

FIGS. 5A-5D illustrate positional relationships between the main light guide 300 and the sub light guides 401 and 402 that are connected to the main light guide 300. FIGS. 6A-6D illustrate positional relationships between the main light guide 300 and all of the sub light guides.

FIG. 4B shows an interface between the connecting member 411 of the sub light guide 401 and the main light guide 300 and between the sub light guide 401 and the main light guide 300. As described above, the cross section D-D shown in FIG. 4B is a yz cross section that is perpendicular to the x-axis. The interface extends substantially in the z-axis direction. The width in the y-axis direction of the interface increases with increase in z coordinate, that is, with increase in distance from the light source 101 in a z-coordinate range, a length of which in the z-axis direction is approximately 60% of the whole length in the z-axis direction of the main light guide 300.

In the cross section A-A shown in FIG. 5A and in the cross section B-B shown in FIG. 5B, the sub light guide 401 is connected to the main light guide 300 via the connecting member 411.

In the cross section C-C shown in FIG. 5C, the sub light guide 401 is connected directly to the main light guide 300 without using the connecting member 411.

In the cross section C′-C′ shown in FIG. 5D and in FIG. 6D, the sub light guide 401 is connected directly to the main light guide 300 without using the connecting member 411 and the sub light guide 402 is connected to the main light guide 300 via the sub light guide 401.

A z-coordinate range of an area in which each sub light guide is connected to the main light guide 300 is different from a z-coordinate range of an area in which any other sub light guide is connected to the main light guide 300 and two adjacent z-coordinate ranges overlap each other. In FIGS. 5A-5D, the interface between the connecting member 411 and the main light guide 300 or the interface between the sub light guide 401 and the main light guide 300 is represented by the alternate long and short dash line.

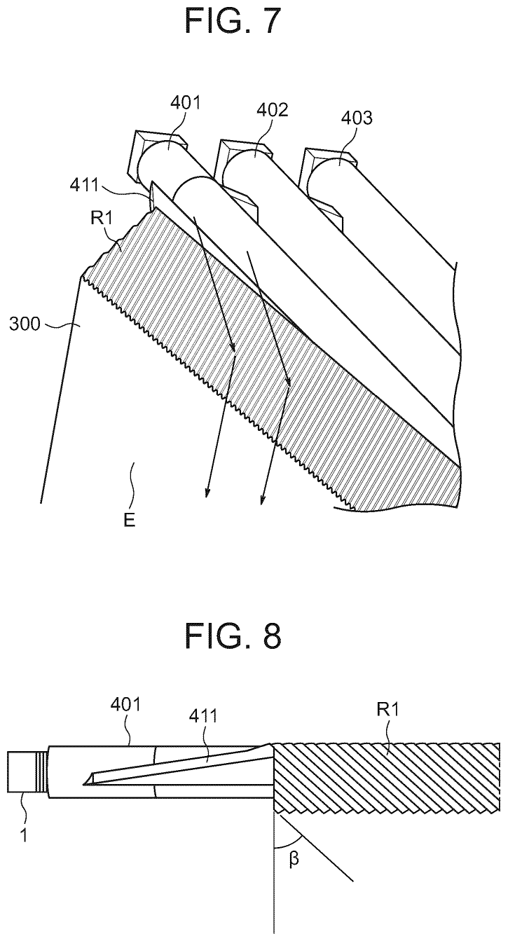

FIG. 7 is a perspective view of the sub light guides and the first reflecting surface R1 of the main light guide 300. In the area shown in FIG. 7, the sub light guide 401 is connected via the connecting member 411 or directly to the main light guide 300. As shown by arrows in FIG. 7, rays of light delivered from the sub light guide 401 reach the first reflecting surface R1 and then are reflected thereon.

FIG. 8 shows the first reflecting surface R1. On the first reflecting surface R1, plural linear grooves are formed. An interval between adjacent grooves and a depth of the grooves are constant. A tilt angle β of the plural linear grooves measured counterclockwise with respect to a projection of the y-axis on the first reflecting surface R1 is in a range from 20 degrees and 50 degrees. As shown in FIG. 2, in the present example rays of light travel inside the sub light guide from the left to the right in the horizontal z-axis direction. When in another embodiment rays of light travel inside the sub light guide from the right to the left in the horizontal z-axis direction, a tilt angle of the plural linear grooves measured clockwise with respect to a projection of the y-axis on the first reflecting surface R1 is in a range from 20 degrees and 50 degrees.

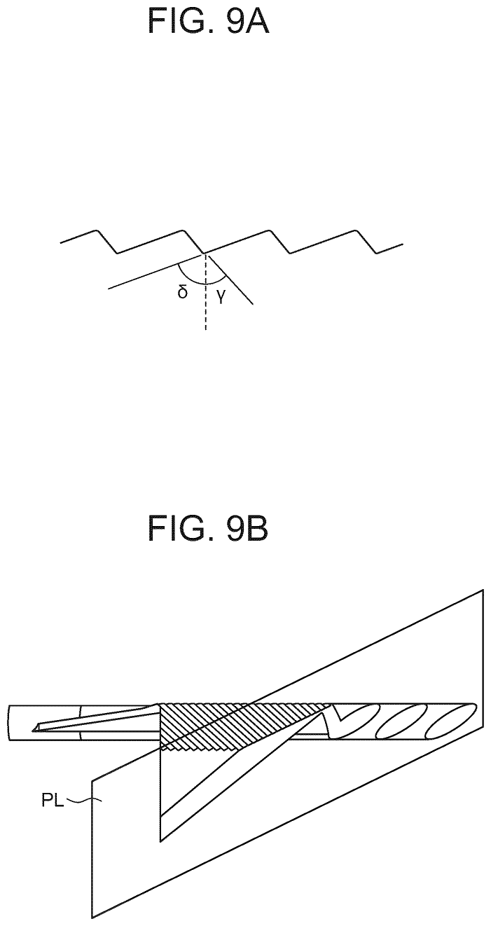

FIG. 9A shows a cross section that is perpendicular to the direction of the plural linear grooves on the first reflecting surface R1.

FIG. 9B illustrates the cross section PL shown in FIG. 9A.

The plural linear grooves are formed by a first set of surfaces that are parallel to one another and a second set of surfaces that are parallel to one another and that are not parallel to the first set of surfaces. In FIG. 9A, the two sets of surfaces are represented by two sets of straight lines. The points of intersection of two straight lines, each of which represents a surface that belongs to each of the two sets, correspond to ridges and bottoms of valleys of the grooves. As shown in 9A, an acute angle γ formed by a straight line corresponding to a surface on the opposite side of a ridge from the second reflecting surface and the depth direction of the grooves is in a range from 35 degrees to 55 degrees. An acute angle δ formed by a straight line corresponding to a surface on the side of the second reflecting surface of a ridge is in a range from 60 degrees to 80 degrees. The depth of the grooves is preferably in a range from 0.05 millimeters to 0.5 millimeters and can be in a range from 0.01 millimeters to 1 millimeter.

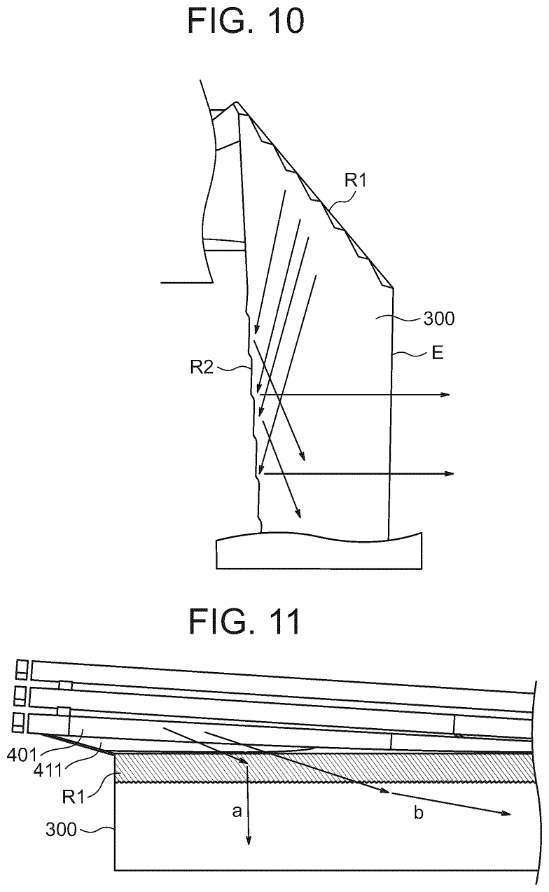

FIG. 10 shows an xy cross section of the first reflecting surface R1 and the surrounding portions of the main light guide 300. Rays of light that have been reflected on the first reflecting surface R1 are further reflected on the second reflecting surface R2 and delivered from the display surface E.

On the second reflecting surface R2, plural linear grooves in the z-axis direction can be formed. An interval between the grooves and a depth of the grooves can be adjusted according to y coordinate. More specifically the interval between the grooves can be made smaller and/or the depth of the grooves can be made greater as a distance in the y-axis direction from the first reflecting surface R1 increases. In general, the second reflecting surface R2 is preferably a diffuse reflection surface that does not generate specular reflection but does generate diffuse reflection (non-specular reflection). Accordingly, the surface can be a textured surface having a surface roughness. An average interval between the plural linear grooves and an average period of a surface roughness of the textured surface and the like is in a range from 0.05 millimeters to 1 millimeter and an average depth of the surface roughness is in a range from 0.01 millimeters to 0.2 millimeters.

FIG. 11 shows a view from diagonally above of the sub light guides and the main light guide. Most of rays of light that have passed through one of the sub light guides reach the second reflecting surface R2 after having been reflected on the first reflecting surface R1 like a ray of light represented by a. On the other hand, some of rays of light that have passed through one of the sub light guides reach the second reflecting surface R2 without being reflected on the first reflecting surface R1 like a ray of light represented by b. When the second reflecting surface R2 is a flat surface, rays of light like a ray of light represented by b may cause nonuniformity in intensity of luminance on the display surface E after having been reflected on the second reflecting surface R2. When the shape of the second reflecting surface R2 is formed as described above, such nonuniformity in intensity of luminance can be prevented.

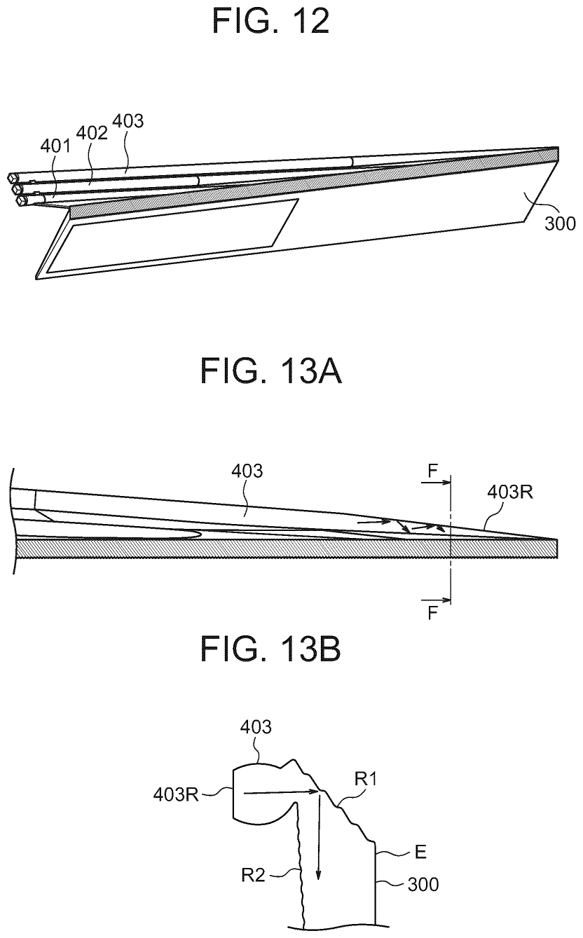

FIG. 12 shows a rectangle area on the display surface E, from the rectangle area rays of light that have passed through the sub light guide 401 being delivered. In a z-coordinate range corresponding to the above-described area, the sub light guide 401 is connected to the main light guide 300.

FIG. 13A shows a plan view of the sub light guide 403, which is connected to the main light guide 300 in a z-coordinate range, z coordinates in the z-coordinate range being greater than corresponding z coordinates of a z-coordinate range in which any other sub light guide is connected to the main light guide 300.

FIG. 13B shows a cross section F-F, the line F-F being shown in FIG. 13A. In an area of the sub light guide 403, z coordinates of the area being relatively great, the outer surface on the opposite side of the sub light guide 403 from the first reflecting surface R1 is formed as a flat surface 403R. An amount of light that reaches the first reflecting surface R1 increases because of reflection on the flat surface 403R.

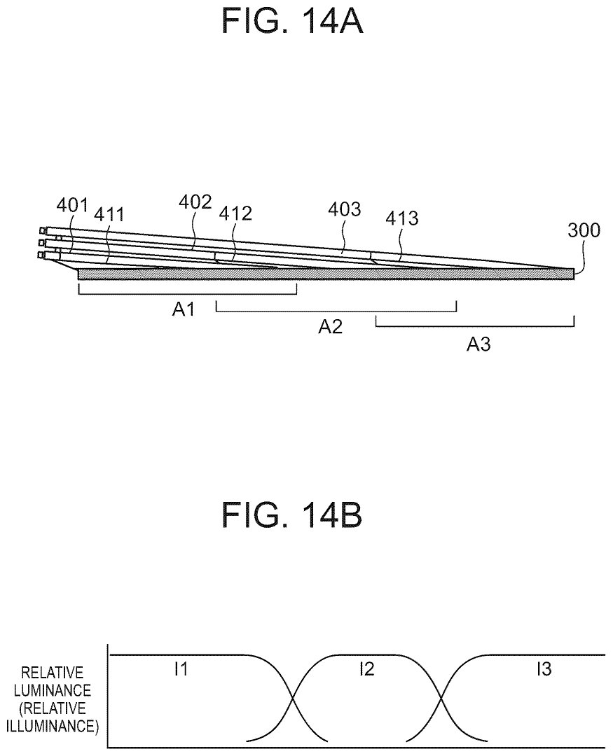

FIG. 14A shows a plan view of the display device like FIG. 1A. In FIG. 14A, areas in each of which each of the sub light guides 401, 402 and 403 is connected to the main light guide 300 are represented respectively by A1, A2 and A3. Among the areas in each of which each sub light guide is connected to the main light guide 300, two areas A1 and A2 that are adjacent to each other in the z-axis direction overlap each other and two areas A2 and A3 that are adjacent to each other in the z-axis direction overlap each other.

FIG. 14B shows a diagram showing distributions of intensity of luminance I1, I2 and I3 in the z-axis direction on the display surface E generated by rays of light that have passed respectively through each of the sub light guides 401, 402 and 403. Each of distributions of intensity of luminance I1, I2 and I3 corresponds respectively to each of the areas A1, A2 and A3. Accordingly, distributions of intensity of luminance I1 and I2 overlap each other and distributions of intensity of luminance I2 and I3 overlap each other.

In a display device according to the embodiment, by changing according to z coordinate a width in the y-axis direction of the interface between the connecting member of each sub light guide and the main light guide or between each sub light guide and the main light guide as shown in FIG. 4B, such a distribution of intensity of luminance in the z-axis direction on the display surface E as shown in FIG. 14B can be adjusted. Further, as shown in FIG. 13B, by making flat the outer surface on the opposite side of a sub light guide from the first reflecting surface R1, the sub light guide being connected to the main light guide in a z-coordinate range, z coordinates in the z-coordinate range being greater than corresponding z coordinates of a z-coordinate range in which any other sub light guide is connected to the main light guide 300, a distribution of intensity of luminance in the z-axis direction can be similarly adjusted.

Further, in a display device according to the embodiment, by selecting appropriate values of angle α shown in FIG. 3, angle β shown in FIG. 8, angle γ shown in FIG. 9A and angle δ shown in FIG. 9A, the values of angle being relevant with the first reflecting surface R1, and by shaping the second reflecting surface R2 appropriately, intensity of luminance on the display surface E can be made greater and a distribution of intensity of luminance in the y-axis direction on the display surface E can be made more uniform. In fact, according to simulations, an average value of luminance on the display surface E. in the case of the first reflecting surface R1 that is provided with the grooves thereon described above is approximately four times as great as an average value of luminance on the display surface E in the case of a first reflecting surface R1 that is not provided with grooves.

Other embodiments will be described below.

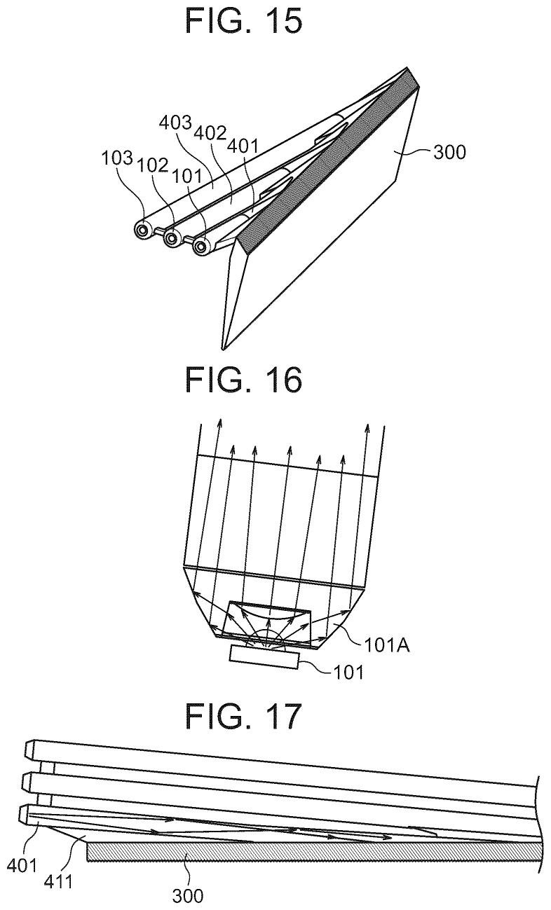

FIG. 15 is a perspective view of a display device including a light source provided with a device for adjusting an angle of divergence.

FIG. 16 shows a cross section of a light source provided with a device for adjusting an angle of divergence. The device 101A for adjusting an angle of divergence includes a lens and a reflecting surface. A half-value angle of divergence of an LED light source without a device for adjusting an angle of divergence is approximately 70 degrees. Using the device for adjusting an angle of divergence, a half-value angle of divergence should preferably be made in a range from 10 degrees to 30 degrees.

FIG. 17 shows a plan view of sub light guides each of which is provided with a light source with a device for adjusting an angle of divergence.

A display device according to the present embodiment brings the following advantages by reducing an angle of divergence. In a display device, some rays of light that have reached the first reflecting surface through one of the sub light guides pass through the first reflecting surface and are delivered to the outside without being reflected by the first reflecting surface. By reducing an angle of divergence of each light source, a ratio of an amount of light delivered to the outside can be reduced so that the efficiency of light can be improved and a higher luminance on the display surface can be obtained. Further, a ratio of an amount of light that have passed through one of the sub light guides and reach the second reflecting surface R2 without being reflected on the first reflecting surface R1 like a ray of light represented by b in FIG. 11 is reduced so that a uniform distribution of intensity of luminance on the display surface can be more easily realized. On the other hand, in the display device according to the present embodiment, a diameter of a cross section of a sub light guide has to be made greater than in the ordinary type because of the presence of the device for adjusting an angle of divergence. Accordingly, a width in the x-axis direction of the main light guide has to be made greater also.

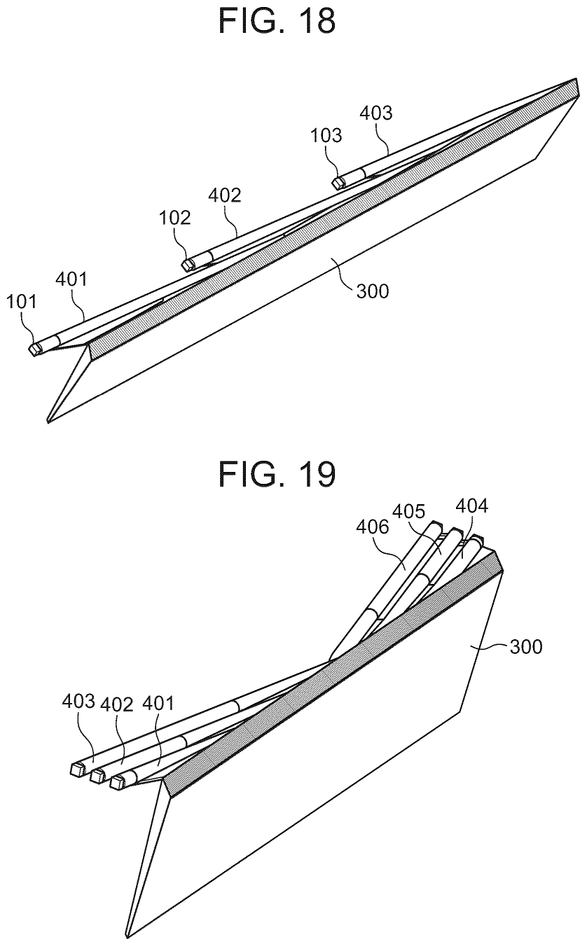

FIG. 18 is a perspective view of a display device in which plural light sources are arranged at relatively great intervals in the z-axis direction. In the display device shown in FIG. 1A, the plural light sources are placed close to one another. In this case, light sources such as LEDs can be installed on a single board and it is advantageous from the standpoint of the cost. On the other hand, a length of the sub light guide 402 and a length of the sub light guide 403 are made relatively great. In the display device shown in FIG. 18, a length of the sub light guide 402 and a length of the sub light guide 403 can be made smaller and therefore the display device can be more easily produced through injection molding. Further, a size in the x-axis direction of the display device can be reduced.

FIG. 19 is a perspective view of a display device in which two sets of three light sources (401, 402, 403) and (404,405,406) are placed in the vicinity of the both ends of a side in the z-axis direction of the display surface. By the structural feature described above, the number of light sources can be increased without increasing a size in the x-axis direction of the display device.

In another embodiment, on the second reflecting surface, diffuse reflection surface areas such as textured areas are partially provided and the other areas on the second reflecting surface are formed as specular surface areas such that a pattern can be generated on the display surface by the partially provided diffuse reflection surface areas.

In still another embodiment, the display surface can be a curved surface that is bent along the y-axis direction and/or along the z-axis direction apart from a flat surface parallel to the y-axis direction and in the z-axis direction.

A display device according to the embodiment can be used with another display device placed nearby the second reflecting surface such that light from both display devices are used for a display on the display surface.

When another display device is not placed nearby the second reflecting surface, a diffuse reflection surface or a specular reflection surface can be placed nearby the second reflecting surface in order to increase intensity of luminance on the display surface by reflection on the diffuse reflection surface or the specular reflection surface of rays of light that have passed through and are delivered from the second reflecting surface.

A display device according to an embodiment includes plural light sources, plural sub light guides and a main light guide. Each sub light guide is of an elongated shape and one of the plural light sources is provided at an end of each sub light guide, the main light guide is provided with a display surface, a first reflecting surface and a second reflecting surface, when the display surface is placed parallel to a y-axis and a z-axis of an xyz coordinate system, each sub light guide is connected to the main light guide in a z-coordinate range that is different from a z-coordinate range in which another sub light guide is connected to the main light guide, a supplementary angle of an angle between the display surface and the first reflecting surface is in a range from 30 degrees to 50 degrees, the display surface and the second reflecting surface face each other, and each sub light guide is connected to the main light guide in an area between the first reflecting surface and the second reflecting surface. Each sub light guide is configured so as to transmit rays of light emitted by a light source at an end of each sub light guide through internal reflection and the main light guide is configured such that rays of light received from each sub light guide are reflected on the first reflecting surface then directly or after having been reflected on the second reflecting surface reach the display surface.

A display device according to the embodiment is featured by that a supplementary angle of an angle between the display surface and the first reflecting surface is in a range from 30 degrees to 50 degrees, the display surface and the second reflecting surface face each other, and each sub light guide is connected to the main light guide in an area between the first reflecting surface and the second reflecting surface. By the structural feature described above, a uniform intensity of luminance on the display surface can be realized through light from respective sub light guides.

In a display device according to another embodiment, a z-coordinate range in which a sub light guide is connected to the main light guide and an adjacent z-coordinate range in which another sub light guide is connected to the main light guide overlap each other.

In a display device according to a still another embodiment, plural linear grooves are formed on the first reflecting surface R1, an interval between adjacent grooves and a depth of the grooves are constant, a tilt angle δ of the plural linear grooves with respect to a projection of the y-axis on the first reflecting surface is in a range from 20 degrees and 50 degrees and the depth of the grooves is in a range from 0.01 millimeters to 1 millimeter.

By the plural linear grooves described above, intensity of luminance on the display surface can be further increased and uniformity of intensity of luminance on the display surface can be further improved.

A display device according to a still another embodiment is a display device according to the second embodiment of the present invention and is featured by that on a cross section that is perpendicular to the direction of the plural linear grooves an acute angle γ formed by a straight line corresponding to a hillside on the opposite side of a ridge from the second reflecting surface and the depth direction of the grooves is in a range from 35 degrees to 55 degrees and an acute angle δ formed by a straight line corresponding to a hillside on the side of the second reflecting surface of a ridge and the depth direction of the grooves is in a range from 60 degrees to 80 degrees.

By the shape of the grooves described above, intensity of luminance and uniformity of intensity of luminance on the display surface are further improved.

In a display device according to a still another embodiment, the second reflecting surface is a diffusion reflection surface.

When a diffusion reflection surface is used as the second reflecting surface, uniformity of intensity of luminance on the display surface is further improved.

In a display device according to a still another embodiment, the display surface and the second reflecting surface are parallel to each other or on a xy cross section of the main light guide, an angle formed by a straight line corresponding to the display surface and a straight line corresponding to the second reflecting surface is 20 degrees or smaller.

In a display device according to a still another embodiment, each light source is configured such that a half-value angle of divergence is in a range from 10 degrees to 30 degrees.

By the structural feature described above, intensity of luminance and of intensity of luminance on the display surface are further improved.

In a display device according to a still another embodiment, the display surface is a curved surface that is bent along the y-axis direction and/or along the z-axis direction such that the curved surface is apart from a flat surface that is parallel to the y-axis direction and to the z-axis direction.

What is claimed is:

1. A display device comprising plural light sources, plural sub light guides and a main light guide,
wherein each sub light guide is of an elongated shape and one of the plural light sources is provided at an end of each sub light guide,
the main light guide is provided with a display surface, a first reflecting surface and a second reflecting surface,
the display surface and the first reflecting surface are adjacent to each other, the display surface and the second reflecting surface face each other, and each sub light guide is connected to the main light guide in an area between the first reflecting surface and the second reflecting surface and
wherein each sub light guide is configured so as to transmit rays of light emitted by a light source at an end of each sub light guide through internal reflection and the main light guide is configured such that rays of light received from each sub light guide are reflected on the first reflecting surface then directly or after having been reflected on the second reflecting surface reach the display surface.

2. The display device according to claim 1, wherein when the display surface is placed parallel to a y-axis and a z-axis of an xyz coordinate system, each sub light guide is connected to the main light guide in a z-coordinate range that is different from a z-coordinate range in which another sub light guide is connected to the main light guide.

3. The display device according to claim 1, wherein a supplementary angle of an angle between the display surface and the first reflecting surface is in a range from 30 degrees to 50 degrees.

4. The display device according to claim 1, wherein a z-coordinate range in which a sub light guide is connected to the main light guide and an adjacent z-coordinate range in which another sub light guide is connected to the main light guide overlap each other.

5. The display device according to claim 1, wherein plural linear grooves are formed on the first reflecting surface R1, an interval between adjacent grooves and a depth of the grooves are constant, a tilt angle δ of the plural linear grooves with respect to a projection of the y-axis on the first reflecting surface is in a range from 20 degrees and 50 degrees and the depth of the grooves is in a range from 0.01 millimeters to 1 millimeter.

6. The display device according to claim 5, wherein on a cross section that is perpendicular to the direction of the plural linear grooves an acute angle γ formed by a straight line corresponding to a hillside on the opposite side of a ridge from the second reflecting surface and the depth direction of the grooves is in a range from 35 degrees to 55 degrees and an acute angle δ formed by a straight line corresponding to a hillside on the side of the second reflecting surface of a ridge and the depth direction of the grooves is in a range from 60 degrees to 80 degrees.

7. The display device according to claim 1, wherein the second reflecting surface is a diffusion reflection surface.

8. The display device according to claim 1, wherein the display surface and the second reflecting surface are parallel to each other or on a xy cross section of the main light guide, an angle formed by a straight line corresponding to the display surface and a straight line corresponding to the second reflecting surface is 20 degrees or smaller.

9. The display device according to claim 1, where each light source is configured such that a half-value angle of divergence is in a range from 10 degrees to 30 degrees.

10. The display device according to claim 1, wherein the display surface is a curved surface that is bent along the y-axis direction and/or along the z-axis direction such that the curved surface is apart from a flat surface parallel to the y-axis direction and to the z-axis direction.
